(19) United States
(12) Patent Application Publication
(10) Pub. No.: US 2024/0201024 A1
(43) Pub. Date: Jun. 20, 2024

(54) INTEGRATED CIRCUIT COMPRISING A TEMPERATURE SENSOR

(71) Applicant: STMicroelectronics International N.V., Geneva (CH)

(72) Inventors: Vincent BINET, Aix en Provence (FR); Sebastien ORTET, Chateauneuf-le-Rouge (FR)

(73) Assignee: STMicroelectronics International N.V., Geneva (CH)

(21) Appl. No.: 18/537,473

(22) Filed: Dec. 12, 2023

(30) Foreign Application Priority Data
Dec. 14, 2022 (FR) 2213391

(51) Int. Cl. G01K 7/01

(52) U.S. Cl. CPC G01K 7/015

(57) ABSTRACT

An integrated circuit temperature sensor includes two diode-connected bipolar transistors having different sizes. A switching circuit selectively applies the base-emitter voltages generated across the two diode-connected bipolar transistors to the input of a buffer circuit. A control unit controls alternate switching by the switching circuit. An analog-to-digital converter has an input connected to an output of the buffer circuit. The analog-to-digital converter calculates a numeric value corresponding to a difference between the voltages generated across the two diode-connected bipolar transistors, this difference in voltages being proportional to absolute temperature.

### PRIORITY CLAIM

This application claims the priority benefit of French Application for Patent No. 2213391, filed on Dec. 14, 2022, the content of which is hereby incorporated by reference in its entirety to the maximum extent allowable by law.

### TECHNICAL FIELD

Embodiments relate to integrated circuits and, in particular, to circuits that include a temperature sensor.

### BACKGROUND

An integrated circuit can comprise a temperature sensor to suit different applications. A temperature sensor can be used to determine a temperature of the silicon in the integrated circuit in order to prevent the temperature of the silicon from rising above a temperature that is suitable for the normal operation of the integrated circuit. In particular, an integrated circuit can be configured so as to reduce an operating frequency of this integrated circuit or to stop supplying power to this integrated circuit when the temperature reaches a given temperature threshold.

A temperature sensor can also be used to measure an ambient temperature when the silicon in the integrated circuit is at the same temperature, in particular when the integrated circuit comprises a package allowing the heat generated during operation of the integrated circuit to be discharged.

A temperature sensor can also be used to counter malicious attacks on the integrated circuit. More specifically, some malicious attacks can involve subjecting the integrated circuit to extreme conditions. In particular, the integrated circuit can be subjected to extreme temperatures so as to alter the operation thereof. Measuring the temperature of the integrated circuit can thus be used to counter a malicious attack when the measured temperature is outside a predefined temperature range. In particular, when such a temperature outside the predefined range is measured, the integrated circuit can be configured to erase security keys or to cut off its power supply.

Known temperature sensors typically comprise a large number of electronic components that can exhibit non-linearities. These non-linearities can accumulate and thus impact the accuracy of the temperature sensor. In order to improve the accuracy of such a temperature sensor, it is important that the temperature sensor is calibrated. Calibration requires carrying out a plurality of temperature measurements at different temperatures. This calibration can be time-consuming and complex and thus expensive.

There is thus a need to provide an integrated circuit comprising a temperature sensor that has a reduced number of electronic elements capable of introducing non-linearities, so as to improve an accuracy of the temperature sensor.

### SUMMARY

According to one aspect, an integrated circuit comprises a temperature sensor that includes: two diode-connected transistors having different sizes; a buffer circuit; a switching circuit configured to be able to selectively apply voltages generated across the two transistors to the input of the buffer circuit; a control unit configured to control the switching circuit so as to successively apply the voltages generated across the two transistors to the input of the buffer circuit; and an analog-to-digital converter having an input connected to the output of the buffer circuit, the analog-to-digital converter being configured to successively convert the voltages supplied by the buffer circuit into numeric voltage values and to calculate a numeric value corresponding to a difference between the numeric values of the voltages generated across the two transistors, this difference in voltages being proportional to absolute temperature and independent of the offset voltages of the analog-to-digital converter and of the buffer circuit.

Such a temperature sensor is thus configured to successively measure the two voltages generated by the diode-connected transistors to calculate a difference in voltages. Such a difference in voltages has the advantage of being solely dependent on temperature.

More particularly, the buffer circuit and the analog-to-digital converter can each have an offset voltage that is added to each voltage measurement. Nonetheless, the voltages generated across the transistors are acquired by the same buffer circuit and by the same analog-to-digital converter. Thus, the difference in voltages calculated by the analog-to-digital converter eliminates the offset voltage of the buffer circuit and the offset voltage of the digital-to-analog converter.

Advantageously, the temperature sensor further comprises: an analog-to-digital converter having an input connected to the output of the buffer circuit, this analog-to-digital converter being configured to convert the voltage corresponding to a difference between these two voltages proportional to temperature, into a numeric value; and a processing unit configured to determine a temperature from the numeric value calculated by the analog-to-digital converter.

In one advantageous embodiment, the processing unit is configured to determine a temperature from the numeric value calculated by the analog-to-digital converter using a look-up table. The advantage of such a temperature sensor is that a temperature of the integrated circuit can be simply determined from a difference in voltages that depends solely on the absolute temperature of the integrated circuit. Such a temperature sensor can thus be calibrated simply and can thus be manufactured at a low cost.

Preferably, the buffer circuit comprises an operational amplifier connected as a follower and having an input that is connected to the switching circuit, the switching circuit being configured so that it can selectively apply the voltages proportional to temperature and generated by the two diode-connected transistors to this input of this operational amplifier.

Advantageously, the two diode-connected transistors are bipolar transistors, each transistor having an emitter as well as a base and a collector that are electrically connected to a ground. Alternatively, these two transistors can be insulated-gate field-effect transistors.

Advantageously, the integrated circuit comprises a proportional-to-absolute-temperature current generator circuit configured to generate a current proportional to absolute temperature.

In one advantageous embodiment, the proportional-to-absolute-temperature current generator circuit comprises: a first diode-connected bipolar transistor and a second diode-connected bipolar transistor; an operational amplifier having an inverting input connected to an emitter of the first bipolar transistor and a non-inverting input connected to an emitter of the second bipolar transistor via a resistor; and two PMOS-type transistors, each having a gate connected to an output of the operational amplifier and a source configured to receive a supply voltage, a first PMOS-type transistor having a drain connected to the inverting input of the operational amplifier and to the emitter of the first bipolar transistor, and a second PMOS-type transistor having a drain connected to the non-inverting input of the operational amplifier and to the emitter of the second bipolar transistor.

In one embodiment, the temperature sensor further comprises an absolute-temperature-sensitive circuit including a third PMOS-type transistor and a third diode-connected bipolar transistor, the third PMOS-type transistor having a gate connected to the output of the operational amplifier of the proportional-to-absolute-temperature current generator circuit, a source configured to receive the supply voltage and a drain connected to an emitter of the third bipolar transistor.

In one embodiment, the absolute-temperature-sensitive circuit further includes a fourth PMOS-type transistor and a fourth diode-connected bipolar transistor, the fourth PMOS-type transistor having a gate connected to the output of the operational amplifier of the proportional-to-absolute-temperature current generator circuit, a source configured to receive the supply voltage and a source drain connected to an emitter of the fourth bipolar transistor.

In one embodiment, the switching circuit is configured to apply either a base-emitter voltage of the third bipolar transistor or a base-emitter voltage of the fourth bipolar transistor to the input of the buffer circuit.

Alternatively, the switching circuit is configured to apply either a base-emitter voltage of the first bipolar transistor or a base-emitter voltage of the third bipolar transistor to the input of the buffer circuit.

Alternatively, the switching circuit is configured to apply either a base-emitter voltage of the first bipolar transistor or a base-emitter voltage of the second bipolar transistor to the input of the buffer circuit.

### BRIEF DESCRIPTION OF THE DRAWINGS

Other advantages and features of the invention will become apparent upon examining the detailed description of non-limiting embodiments, and from the accompanying drawings in which:

FIG. 1 shows a first embodiment of an integrated circuit comprising a temperature sensor;

FIG. 2 shows a second embodiment of an integrated circuit comprising a temperature sensor; and

FIG. 3 shows a second embodiment of an integrated circuit IC comprising a temperature sensor.

### DETAILED DESCRIPTION

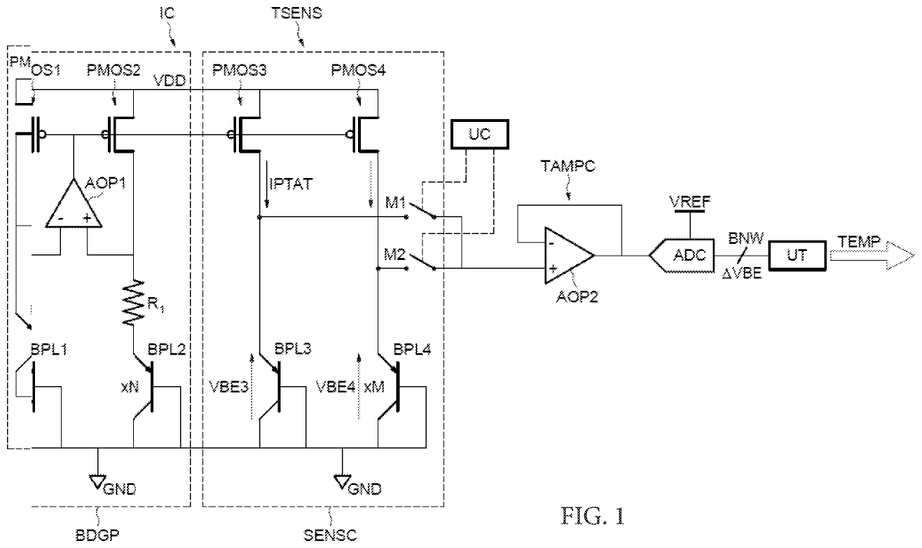

FIG. 1 shows a first embodiment of an integrated circuit IC comprising a temperature sensor TSENS.

The temperature sensor TSENS includes a proportional-to-absolute-temperature current generator circuit BDGP (also referred to as a bandgap circuit).

The generator circuit BDGP comprises two bipolar transistors BPL1, BPL2. Each bipolar transistor BPL1, BPL2 is a diode-connected transistor.

Each transistor BPL1, BPL2 has an emitter, a collector and a base, the base being electrically connected to the collector and to a ground GND. The bipolar transistors BPL1, BPL2 have different sizes. The size of a bipolar transistor BPL1, BPL2 corresponds to the surface area of the emitter of this bipolar transistor. In particular, a ratio between the sizes of the bipolar transistors BPL1, BPL2 is equal to N, where N can be between 4 and 32 (for example).

The generator circuit BDGP further comprises an operational amplifier AOP1. The operational amplifier AOP1 has an inverting input electrically connected to the emitter of the first bipolar transistor BPL1. The operational amplifier AOP1 further has a non-inverting input electrically connected to the emitter of the second bipolar transistor BPL2 via a resistive element R₁. The resistive value of the resistive element R₁ is chosen to adjust the value of the current through the resistive element R₁ so that it is proportional to absolute temperature.

The generator circuit BDGP further comprises two PMOS-type transistors PMOS1, PMOS2 (i.e., P-channel metal-oxide gate field-effect transistors). A first transistor PMOS1 has a gate connected to an output of the operational amplifier AOP1, a source configured to receive a voltage VDD and a drain connected to the inverting input of the operational amplifier AOP1 and to the emitter of the first bipolar transistor BPL1.

A second transistor PMOS2 has a gate connected to the output of the operational amplifier AOP1, a source configured to receive a voltage VDD and a drain connected to the non-inverting input of the operational amplifier AOP1 and to the emitter of the second bipolar transistor BPL2 via the resistor R₁.

The operational amplifier AOP1 allows the voltages of the signals it receives at the non-inverting input and the inverting input thereof to be equalized. Thus, the base-emitter voltage of the first transistor BPL1 is the same as the voltage at the terminal of the resistor R₁ connected to the non-inverting input of the operational amplifier AOP1.

This generates a current across the resistor R₁.

The temperature sensor TSENS further comprises a temperature-sensitive circuit SENSC. This temperature-sensitive circuit comprises two branches BRCH1, BRCH2, each of which includes a bipolar transistor BPL3 and BPL4. Each bipolar transistor BPL3, BPL4 is a diode-connected transistor.

Each bipolar transistor BPL3, BPL4 has an emitter, a collector and a base, the base being electrically connected to the collector and to a ground GND. The bipolar transistors BPL3, BPL4 have different sizes. In particular, a ratio between the sizes of the bipolar transistors BPL3, BPL4 is equal to M, where M can be between 4 and 32 (for example).

Each branch BRCH1, BRCH2 further includes a PMOS-type transistor (i.e., P-channel metal-oxide gate field-effect transistors).

In particular, the first branch BRCH1 comprises a third transistor PMOS3, which has a gate connected to an output of the operational amplifier AOP1, a source configured to receive a voltage VDD and a drain connected to the emitter of the third bipolar transistor BPL3.

The second branch BRCH2 comprises a fourth transistor PMOS4, which has a gate connected to the output of the operational amplifier AOP1, a source configured to receive a voltage VDD and a drain connected to the emitter of the fourth bipolar transistor BPL4.

The third transistor PMOS3 and the fourth transistor PMOS4 are configured to copy the current flowing through the resistor R₁ to the first branch BRCH1 and to the second branch BRCH2, and a current IPTAT proportional to absolute temperature thus flows through these branches BRCH1 and BRCH2. The current flowing through the resistor R₁ can, in particular, be copied by the transistors PMOS3 and PMOS4 with a copy factor β between the transistors PMOS3 and PMOS4, where β is greater than or equal to 1.

The third transistor PMOS3 and the fourth transistor PMOS4 are identical. Alternatively, the transistors PMOS3 and PMOS4 have different sizes. In particular, a ratio between the sizes of the transistors PMOS3, PMOS4 can be equal to M, where M can be between 4 and 32. In the latter case, the transistors BPL3 and BPL4 are identical.

This creates a base-emitter voltage VBE3 on the third bipolar transistor BPL3 and a base-emitter voltage VBE4 on the fourth bipolar transistor. The difference between the base-emitter voltage VBE4 and the base-emitter voltage VBE3 is thus proportional to absolute temperature (referred to by the acronym “PTAT”)

The temperature sensor TSENS further comprises a buffer circuit TAMPC. This buffer circuit TAMPC comprises an operational amplifier AOP2 connected as a follower. The operational amplifier AOP2 has a non-inverting input electrically connected to the emitter of the third bipolar transistor via a switch M1 and to the emitter of the fourth bipolar transistor via a switch M2. The operational amplifier AOP2 also has an inverting input connected to an output of this operational amplifier AOP2.

The temperature sensor further includes a control unit UC configured to control the switches M1 and M2.

In particular, the control unit UC is configured to alternately open and close the switches M1 and M2. Thus, when the switch M1 is closed, the switch M2 is open. When the switch M1 is open, the switch M2 is closed. In this way, the base-emitter voltage VBE3 and the base-emitter voltage VBE4 are alternately applied (i.e., sampled) to the non-inverting input of the operational amplifier AOP2.

The temperature sensor TSENS also comprises an analog-to-digital converter ADC. The analog-to-digital converter ADC has a first input connected to the output of the operational amplifier AOP2.

The analog-to-digital converter ADC also has a second input configured to receive a voltage VREF. This voltage VREF is a temperature-independent voltage. In particular, the integrated circuit IC comprises a circuit for generating a reference voltage (not shown) allowing this voltage VREF to be generated. For example, the circuit for generating the voltage VREF can be obtained from a bandgap voltage reference allowing the voltage VREF to be generated and a buffer circuit allowing the reference voltage VREF to be kept constant at the output of this buffer circuit.

The switches M1 and M2 are controlled so as to successively obtain the base-emitter voltage VBE3 and the base-emitter voltage VBE4 at the output of the buffer circuit TAMPC.

The analog-to-digital converter ADC is configured to receive the voltages VBE3, VBE4 supplied one after the other from the buffer circuit, and then to convert each of these two voltages VBE3, VBE4 into a numeric value before calculating a difference between these numeric voltage values to obtain the value ΔVBE. The value ΔVBE is then output from the analog-to-digital converter ADC as a multi-bit digital numeric word BNW.

The voltages VBE3 and VBE4 are acquired by the same operational amplifier AOP2 and by the same analog-to-digital converter ADC. This eliminates an offset voltage from the operational amplifier AOP2 in the output signal thereof, as well as an offset voltage from the digital-to-analog converter ADC. Thus, the output voltage of the assembly comprising the operational amplifier AOP2 and the analog-to-digital converter ADC solely depends on the temperature and on constants. In particular, the difference in voltages ΔVBE is equal to

$$\frac{kT}{q} ln ( M \times β ) ,$$

where k is the Boltzmann constant, q is the charge of an electron, T is the temperature, and M is the ratio between the sizes of the bipolar transistors BPL3 and BPL4, and B is the current ratio between the transistors PMOS3 and PMOS4.

Since the generator circuit BDGP and the temperature-sensitive circuit SENSC have few electronic components, the difference in voltages ΔVBE is only slightly impacted by the non-linearities from the electronic components. In particular, the transistors PMOS1, PMOS2, PMOS3 and PMOS4 can introduce sufficiently small non-linearities so as to not have an impact on the difference in voltages ΔVBE.

The integrated circuit IC further comprises a processing unit UT. This processing unit UT is configured to determine a temperature value TEMP from the numeric word BNW generated by the analog-to-digital converter ADC corresponding to the difference in voltages ΔVBE. This temperature value TEMP can be obtained from a look-up table obtained during a step of calibrating the integrated circuit IC and stored in a memory of the integrated circuit (not shown).

The performance of the temperature sensor TSENS can be adjusted using the ratio M between the sizes of the bipolar transistors BPL3 and BPL4 and also using the ratio β of the current copies carried out by the transistors PMOS3 and PMOS4.

The advantage of such a temperature sensor is that the temperature of the integrated circuit is determined from a difference in voltage ΔVBE that depends solely on temperature. In this way, such a temperature sensor is accurate and can be calibrated quickly. Such a temperature sensor can thus be manufactured at a low cost.

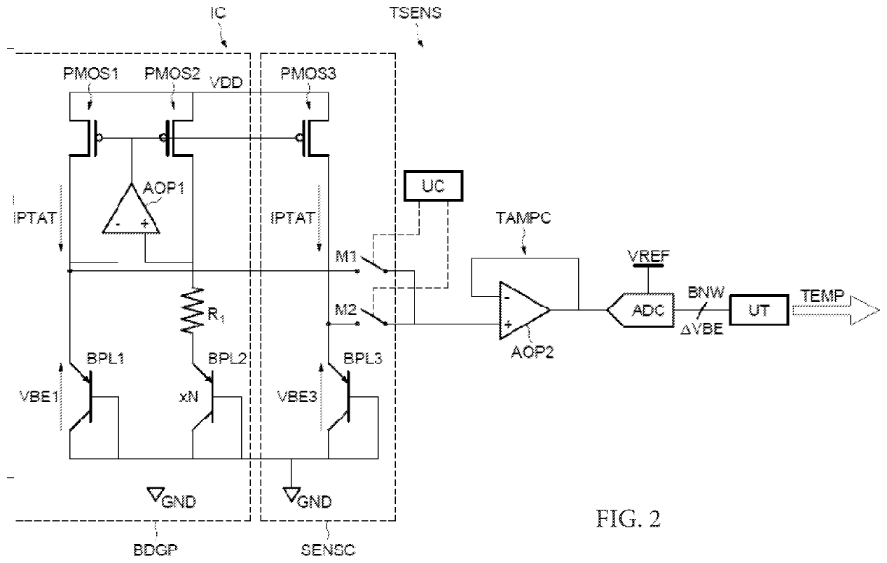

FIG. 2 shows a second embodiment of an integrated circuit IC comprising a temperature sensor TSENS.

The integrated circuit IC includes a proportional-to-absolute-temperature current generator circuit BDGP identical to that described above. The generator circuit BDGP thus comprises two bipolar transistors BPL1, BPL2, an operational amplifier AOP1, a resistor R₁ and two PMOS-type transistors PMOS1, PMOS2, as described above.

The temperature sensor TSENS further comprises a temperature-sensitive circuit SENSC. This temperature-sensitive circuit comprises a single branch BRCH1 which includes a bipolar transistor BPL3. This bipolar transistor BPL3 is a diode-connected transistor.

This bipolar transistor BPL3 has an emitter, a collector and a base, the base being electrically connected to the collector and to a ground GND. The bipolar transistor BPL3 has sizes that differ from those of the transistor BPL1. In particular, a ratio between the sizes of the bipolar transistors BPL3 and BPL1 is equal to M, where M can be between 4 and 32 (for example).

The branch BRCH1 further includes a third PMOS-type transistor PMOS3 (i.e., P-channel metal-oxide gate field-effect transistors). This third transistor PMOS3 has a gate connected to an output of the operational amplifier AOP1, a source configured to receive a voltage VDD and a drain connected to the emitter of the third bipolar transistor BPL3.

The third transistor PMOS3 is configured to copy the current passing through the resistor R₁ to the first branch BRCH1 with a copy factor 1/β, where β is greater than or equal to 1.

This creates a base-emitter voltage VBE3 on the third bipolar transistor BPL3. This base-emitter voltage VBE3 is thus dependent on absolute temperature.

The temperature sensor TSENS further comprises a buffer circuit TAMPC. This buffer circuit TAMPC comprises an operational amplifier AOP2 connected as a follower. In particular, the operational amplifier AOP2 has a non-inverting input electrically connected to the emitter of the first bipolar transistor BPL1 via a switch M1 and to the emitter of the third bipolar transistor BPL3 via a switch M2. The operational amplifier AOP2 also has an inverting input connected to an output of this operational amplifier AOP2.

The temperature sensor TSENS further includes a control unit UC configured to control the switches M1 and M2.

In particular, the control unit UC is configured to alternately open and close the switches M1 and M2. Thus, when the switch M1 is closed, the switch M2 is open. When the switch M1 is open, the switch M2 is closed. In this way, the base-emitter voltage VBE1 of the first bipolar transistor BLP1 and the base-emitter voltage VBE3 of the third bipolar transistor BLP3 are alternately applied (i.e., sampled) to the non-inverting input of the operational amplifier AOP2.

The temperature sensor TSENS also comprises an analog-to-digital converter ADC. The analog-to-digital converter ADC has a first input connected to the output of the operational amplifier AOP2.

The analog-to-digital converter ADC also has a second input configured to receive a voltage VREF. This voltage VREF is a temperature-independent voltage. In particular, the integrated circuit IC comprises a circuit for generating a reference voltage (not shown) allowing this voltage VREF to be generated. For example, the circuit for generating the voltage VREF can be obtained from a bandgap voltage reference allowing the voltage VREF to be generated and a buffer circuit allowing the reference voltage VREF to be kept constant at the output of this buffer circuit.

The switches M1 and M2 are controlled so as to successively obtain the base-emitter voltage VBE1 and the base-emitter voltage VBE3 at the output of the buffer circuit TAMPC.

The analog-to-digital converter ADC is configured to receive the voltages VBE1, VBE3 supplied one after the other from the buffer circuit, and then to convert these two voltages VBE1, VBE3 into a numeric value before calculating a difference between these numeric voltage values to obtain the value ΔVBE. The value ΔVBE is then output from the analog-to-digital converter ADC as a multi-bit digital numeric word BNW.

The voltages VBE1 and VBE3 are acquired by the same operational amplifier AOP2 and by the same analog-to-digital converter. This eliminates an offset voltage from the operational amplifier AOP2 in the output signal thereof, but also an offset voltage from the analog-to-digital converter ADC. Thus, the difference in voltages ΔVBE at the output of the analog-to-digital converter depends solely on temperature and constants. In particular, the difference in voltages ΔVBE is equal to

$$\frac{kT}{q} ln ( M \times β ) ,$$

where k is the Boltzmann constant, q is the charge of an electron, T is the temperature, M is the ratio between the sizes of the bipolar transistors BPL1 and BPL3, and 1/β is the current ratio between the transistors PMOS1 and PMOS3.

The integrated circuit IC further comprises a processing unit UT. This processing unit UT is configured to determine a temperature value TEMP from the numeric value BNW generated by the analog-to-digital converter ADC relative to the voltage VREF.

The performance of the temperature sensor TSENS can be adjusted with the ratio M between the sizes of the bipolar transistors BLP1 and BLP3 and also with the ratio 1/β of the current copies carried out by the transistors PMOS1 and PMOS3.

Another advantage of such a temperature sensor is that the temperature is determined from a difference in voltage ΔVBE that depends solely on temperature. In this way, such a temperature sensor is accurate and can be calibrated quickly. Such a temperature sensor can thus be manufactured at a low cost.

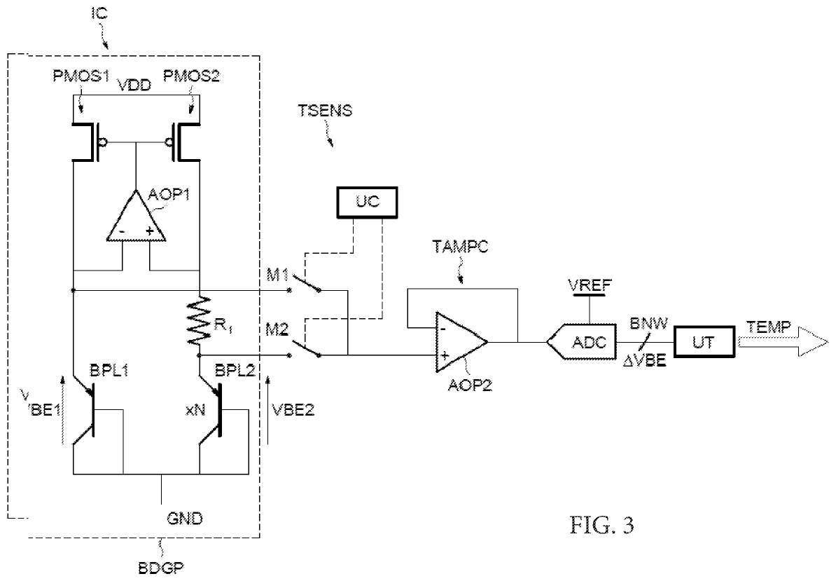

FIG. 3 shows a third embodiment of an integrated circuit IC.

The integrated circuit IC includes a proportional-to-absolute-temperature current generator circuit BDGP identical to that described above. The generator circuit BDGP thus comprises two bipolar transistors BPL1, BPL2, an operational amplifier AOP1, a resistor R₁ and two PMOS-type transistors PMOS1, PMOS2, as described above.

The integrated circuit IC further comprises a buffer circuit TAMPC. This buffer circuit TAMPC comprises an operational amplifier AOP2 connected as a follower. In particular, the operational amplifier AOP2 has a non-inverting input electrically connected to the emitter of the first bipolar transistor BLP1 via a switch M1 and to the emitter of the second bipolar transistor BLP2 via a switch M2. The operational amplifier AOP2 also has an inverting input connected to an output of this operational amplifier AOP2.

The temperature sensor TSENS further includes a control unit UC configured to control the switches M1 and M2.

In particular, the control unit UC is configured to alternately open and close the switches M1 and M2. Thus, when the switch M1 is closed, the switch M2 is open. When the switch M1 is open, the switch M2 is closed. In this way, the base-emitter voltage VBE1 of the first bipolar transistor BPL1 and the base-emitter voltage VBE2 of the second bipolar transistor BPL2 are alternately applied (i.e., sampled) to the non-inverting input of the operational amplifier AOP2.

The temperature sensor TSENS also comprises an analog-to-digital converter ADC. The analog-to-digital converter ADC has a first input connected to the output of the operational amplifier AOP2.

The analog-to-digital converter ADC also has a second input configured to receive a voltage VREF. This voltage VREF is a temperature-independent voltage. In particular, the integrated circuit IC comprises a circuit for generating a reference voltage (not shown) allowing this voltage VREF to be generated. For example, the circuit for generating the voltage VREF can be obtained from a bandgap voltage reference allowing the voltage VREF to be generated and a buffer circuit allowing the reference voltage VREF to be kept constant at the output of this buffer circuit.

The switches M1 and M2 are controlled so as to successively obtain the base-emitter voltage VBE1 and the base-emitter voltage VBE2 at the output of the buffer circuit TAMPC.

The analog-to-digital converter ADC is configured to receive the voltages VBE1, VBE2 supplied one after the other from the buffer circuit, and then to convert these two voltages VBE1, VBE2 into a numeric value before calculating a difference between these numeric voltage values to obtain the value ΔVBE. The value ΔVBE is then output from the analog-to-digital converter ADC as a multi-bit digital numeric word BNW.

The voltages VBE1 and VBE2 are acquired by the same operational amplifier AOP2 and by the same analog-to-digital converter ADC. This eliminates an offset voltage from the operational amplifier AOP2 in the output signal thereof, as well as an offset voltage from the analog-to-digital converter ADC. Thus, the difference in voltages ΔVBE at the output of the analog-to-digital converter ADC depends solely on temperature and constants. In particular, the difference in voltages ΔVBE is equal to

$$\frac{kT}{q} ln ( M ) ,$$

where k is the Boltzmann constant, q is the charge of an electron, T is the temperature, and M is the ratio between the sizes of the bipolar transistors BPL1 and BPL2.

Since the generator circuit BDGP has few electronic components, the difference in voltages ΔVBE is only slightly impacted by the non-linearities from the electronic components. In particular, the transistors PMOS1, PMOS2 can introduce sufficiently small non-linearities that they have little or no impact on the difference in voltages ΔVBE.

The integrated circuit IC further comprises a processing unit UT. This processing unit UT is configured to determine a temperature value TEMP from the numeric value BNW generated by the analog-to-digital converter ADC.

The advantage of such a temperature sensor is that the temperature is determined from a difference in voltage ΔVBE that depends solely on temperature. In this way, such a temperature sensor is accurate and can be calibrated quickly. Such a temperature sensor can thus be manufactured at a low cost.

The integrated circuit IC can comprise a plurality of temperature sensors TSENS such as those described hereinabove, in order to determine the temperature at different locations in the integrated circuit.

1. An integrated circuit, comprising a temperature sensor that includes:
first and second diode-connected transistors having different sizes;
a buffer circuit;
a switching circuit;
a control unit configured to control the switching circuit to successively apply a voltage generated across the first diode-connected transistor and a voltage generated across the second diode-connected transistor to an input of the buffer circuit;
an analog-to-digital converter having an input connected to an output of the buffer circuit, the analog-to-digital converter configured to successively convert voltages output from the buffer circuit into numeric voltage values corresponding to the voltages generated across the first and second diode-connected transistors and to calculate a numeric value corresponding to a difference between the numeric values, wherein the numeric value is proportional to absolute temperature and independent of offset voltages of the analog-to-digital converter and the buffer circuit.

2. The integrated circuit according to claim 1, wherein the temperature sensor further includes a processing unit configured to determine a temperature from the numeric value calculated by the analog-to-digital converter.

3. The integrated circuit according to claim 2, wherein the processing unit is configured to determine a temperature from the numeric value calculated by the analog-to-digital converter using a look-up table.

4. The integrated circuit according to claim 1, wherein the buffer circuit comprises an operational amplifier connected as a follower.

5. The integrated circuit according to claim 1, wherein each of the first and second diode-connected transistors is a bipolar transistor, each bipolar transistor having an emitter, a base electrically connected to ground and a collector electrically connected to ground.

6. The integrated circuit according to claim 1, further comprising a proportional-to-absolute-temperature current generator circuit configured to generate a current that is proportional to absolute temperature.

7. The integrated circuit according to claim 6, wherein the proportional-to-absolute-temperature current generator circuit comprises:
a first diode-connected bipolar transistor;
a second diode-connected bipolar transistor;
an operational amplifier having an inverting input connected to an emitter of the first diode-connected bipolar transistor and a non-inverting input connected to an emitter of the second diode-connected bipolar transistor via a resistor;
a first PMOS-type transistor having a gate connected to an output of the operational amplifier and a drain connected to the inverting input of the operational amplifier and to the emitter of the first diode-connected bipolar transistor; and
a second PMOS-type transistor having a gate connected to an output of the operational amplifier and a drain connected to the non-inverting input of the operational amplifier and to the emitter of the second diode-connected bipolar transistor via the resistor.

8. The integrated circuit according to claim 7, wherein the temperature sensor further comprises an absolute-temperature-sensitive circuit including a third PMOS-type transistor and a third diode-connected bipolar transistor, the third PMOS-type transistor having a gate connected to the output of the operational amplifier of the proportional-to-absolute-temperature current generator circuit and a drain connected to an emitter of the third diode-connected bipolar transistor.

9. The integrated circuit according to claim 8, wherein the absolute-temperature-sensitive circuit further includes a fourth PMOS-type transistor and a fourth diode-connected bipolar transistor, the fourth PMOS-type transistor having a gate connected to the output of the operational amplifier of the proportional-to-absolute-temperature current generator circuit and a drain connected to an emitter of the fourth diode-connected bipolar transistor.

10. The integrated circuit according to claim 9, wherein the switching circuit is configured to apply either a base-emitter voltage of the third diode-connected bipolar transistor or a base-emitter voltage of the fourth diode-connected bipolar transistor to the input of the buffer circuit.

11. The integrated circuit according to claim 8, wherein the switching circuit is configured to apply either a base-emitter voltage of the first diode-connected bipolar transistor or a base-emitter voltage of the third diode-connected bipolar transistor to the input of the buffer circuit.

12. The integrated circuit according to claim 7, wherein the switching circuit is configured to apply either a base-emitter voltage of the first diode-connected bipolar transistor or a base-emitter voltage of the second diode-connected bipolar transistor to the input of the buffer circuit.

13. An integrated circuit temperature sensor, comprising:
a bandgap circuit comprising:
a first diode-connected bipolar transistor;
a second diode-connected bipolar transistor;
an operational amplifier having an inverting input connected to an emitter of the first diode-connected bipolar transistor and a non-inverting input connected to an emitter of the second diode-connected bipolar transistor via a resistor;
a first PMOS-type transistor having a gate connected to an output of the operational amplifier and a drain connected to the inverting input of the operational amplifier and to the emitter of the first bipolar transistor; and
a second PMOS-type transistor having a gate connected to an output of the operational amplifier and a drain connected to the non-inverting input of the operational amplifier and to the emitter of the second bipolar transistor via the resistor;
a temperature sensitive circuit comprising:
a third PMOS-type transistor and a third diode-connected bipolar transistor, the third PMOS-type transistor having a gate connected to the output of the operational amplifier and a drain connected to an emitter of the third diode-connected bipolar transistor; and
a fourth PMOS-type transistor and a fourth diode-connected bipolar transistor, the fourth PMOS-type transistor having a gate connected to the output of the operational amplifier and a drain connected to an emitter of the fourth diode-connected bipolar transistor;
a sampling circuit configured to alternately sample base-emitter voltages of the third and fourth diode-connected bipolar transistors; and
an analog-to-digital converter circuit configured to convert the alternately sampled base-emitter voltages into numeric voltage values and to calculate a numeric value corresponding to a difference between the numeric values, wherein the numeric value is proportional to absolute temperature.

14. The integrated circuit temperature sensor according to claim 13, further comprising a processing unit configured to determine a temperature from the numeric value calculated by the analog-to-digital converter.

15. An integrated circuit temperature sensor, comprising:
a bandgap circuit comprising:
a first diode-connected bipolar transistor;
a second diode-connected bipolar transistor;
an operational amplifier having an inverting input connected to an emitter of the first diode-connected bipolar transistor and a non-inverting input connected to an emitter of the second diode-connected bipolar transistor via a resistor;
a first PMOS-type transistor having a gate connected to an output of the operational amplifier and a drain connected to the inverting input of the operational amplifier and to the emitter of the first bipolar transistor; and
a second PMOS-type transistor having a gate connected to an output of the operational amplifier and a drain connected to the non-inverting input of the operational amplifier and to the emitter of the second bipolar transistor via the resistor;
a temperature sensitive circuit comprising:
a third PMOS-type transistor and a third diode-connected bipolar transistor, the third PMOS-type transistor having a gate connected to the output of the operational amplifier and a drain connected to an emitter of the third diode-connected bipolar transistor;
a sampling circuit configured to alternately sample base-emitter voltages of the first and third diode-connected bipolar transistors; and
an analog-to-digital converter circuit configured to convert the alternately sampled base-emitter voltages into numeric voltage values and to calculate a numeric value corresponding to a difference between the numeric values, wherein the numeric value is proportional to absolute temperature.

16. The integrated circuit temperature sensor according to claim 15, further comprising a processing unit configured to determine a temperature from the numeric value calculated by the analog-to-digital converter.

17. An integrated circuit temperature sensor, comprising:
a bandgap circuit comprising:
a first diode-connected bipolar transistor;
a second diode-connected bipolar transistor;
an operational amplifier having an inverting input connected to an emitter of the first diode-connected bipolar transistor and a non-inverting input connected to an emitter of the second diode-connected bipolar transistor via a resistor;
a first PMOS-type transistor having a gate connected to an output of the operational amplifier and a drain connected to the inverting input of the operational amplifier and to the emitter of the first bipolar transistor; and
a second PMOS-type transistor having a gate connected to an output of the operational amplifier and a drain connected to the non-inverting input of the operational amplifier and to the emitter of the second bipolar transistor via the resistor;
a sampling circuit configured to alternately sample base-emitter voltages of the first and second diode-connected bipolar transistors; and
an analog-to-digital converter circuit configured to convert the alternately sampled base-emitter voltages into numeric voltage values and to calculate a numeric value corresponding to a difference between the numeric values, wherein the numeric value is proportional to absolute temperature.

18. The integrated circuit temperature sensor according to claim 17, further comprising a processing unit configured to determine a temperature from the numeric value calculated by the analog-to-digital converter.
